(19) United States
(12) Patent Application Publication
(10) Pub. No.: US 2016/0182193 A1
(43) Pub. Date: Jun. 23, 2016

(54) BASE STATION APPARATUS, TERMINAL APPARATUS, AND INTEGRATED CIRCUIT

(71) Applicant: SHARP KABUSHIKI KAISHA, Osaka-shi, Osaka (JP)

(72) Inventors: Hiromichi TOMEBA, Osaka-shi (JP); Ryota YAMADA, Osaka-shi (JP); Kozue YOKOMAKURA, Osaka-shi (JP); Katsuya KATO, Osaka-shi (JP)

(73) Assignee: SHARP KABUSHIKI KAISHA, Osaka-shi, Osaka (JP)

(21) Appl. No.: 14/905,593

(22) PCT Filed: Jul. 28, 2014
(86) PCT No.: PCT/JP2014/069864

§ 371 Date: Jan. 15, 2016

(30) Foreign Application Priority Data
Aug. 5, 2013 (JP) 2013-162120

(51) Int. Cl. H04L 1/18; H04J 11/00; H04B 7/04

(52) U.S. Cl. CPC H04L 1/1819; H04B 7/0452; H04J 11/005

(57) ABSTRACT

Provided are a base station apparatus, a terminal apparatus, and an integrated circuit, by which the terminal apparatus performing interference suppression and cancellation is able to efficiently suppress an interference signal. The base station apparatus of the invention is a base station apparatus that notifies a first terminal apparatus of terminal information which is information of a second terminal apparatus and which causes interference. The base station apparatus always transmits, to the terminal apparatus performing interference suppression, a coded bit sequence, which includes the large number of systematic bits, regardless of a state of retransmission request, and notifies the terminal information of an interference signal. The terminal apparatus suppresses the interference signal based on the terminal information, and detects a desired signal from the coded bit sequence.

### TECHNICAL FIELD

The present invention relates to a base station apparatus, a terminal apparatus, and an integrated circuit which perform interference suppression and cancellation.

### BACKGROUND ART

In a wireless communication system, increase of transmission speed is constantly desired in order to provide various broadband information services. The increase of transmission speed is able to be realized by expanding a communication bandwidth, but there is limitation to an available frequency band, and thus it becomes essential to improve frequency efficiency. Then, multi user-MIMO (MU-MIMO) in which a plurality of terminal apparatuses connected at the same time are regarded as a virtual large-scale array antenna and signals transmitted from a base station apparatus to each of the terminal apparatuses are spatially multiplexed is effective in improving the frequency efficiency. In the MU-MIMO, there is a problem that a transmitted signal to one of the terminal apparatuses is received by the other terminal apparatuses as inter-user-interference (IUI).

Moreover, in order to increase a system capacity, high-density array of base stations by using a heterogeneous network has been studied. The high-density array of base stations is aimed at decreasing a load of a macro base station by arraying a low power base station (LPN: Low Power Node) and the like in a macro cell and a terminal apparatus being connected to the low power base station. In this case, inter-cell-interference (ICI) becomes a problem.

To cope with such IUI and ICI, in a 3GPP (3rd Generation Partnership Project), NAICS (Network Assisted Interference Cancellation and Suppression) in which a terminal apparatus suppresses or cancels an interference signal has been studied. In the NAICS, the terminal apparatus receives information about a different interfering terminal apparatus and detects a signal addressed to the different interfering terminal apparatus for performing interference cancellation. The NAICS is described in NPL 1.

### CITATION LIST

### Non Patent Literature

NPL 1: RP-130404, “Study on Network-Assisted Interference Cancellation and Suppression for LTE,” 3GPP TSG RAN Meeting #59, March 2013.

### SUMMARY OF INVENTION

### Technical Problem

In many wireless communication systems, hybrid automatic repeat request (HARQ) is performed. The HARQ is a packet transmission method in which an error correction code and an automatic repeat request are combined. In the HARQ, when an error is detected in a received data signal, a terminal apparatus requests a base station apparatus to perform retransmission. In response to the retransmission request from the terminal apparatus, the base station apparatus transmits an information bit or a coding bit again. By combining an initially transmitted signal which has been held and a retransmitted signal which is received, the terminal apparatus is able to perform error correction efficiently. IR (Incremental Redundancy) is one of HARQ schemes. With the IR, a data signal is subjected to error correction coding with a certain coding rate, and bits are removed therefrom (subjected to puncturing) so as to achieve a desired coding rate, and then an initial transmission signal is transmitted. Then, a bit sequence different from that in the initially transmitted signal is transmitted as a retransmitted signal. Since the coding rate is lowered when combining the initially transmitted signal and the retransmitted signal, error correction performance is improved.

However, since an interference signal is detected and cancelled in the NAICS, when only the retransmitted signal is multiplexed as an interference signal, there is no initial transmission signal of the interference signal and error correction accuracy of the interference signal deteriorates considerably, so that the interference cancellation performance is lowered.

The invention has been made in view of such circumstance and an object thereof is to provide a base station apparatus, a terminal apparatus, and an integrated circuit which are capable of accurately performing detection of a desired signal in a wireless communication system in which HARQ is used.

### Solution to Problem

(1) In order to achieve the aforementioned object, the following means is taken in the invention. That is, a base station apparatus of the invention is a base station apparatus that notifies a first terminal apparatus of terminal information which is information of a second terminal apparatus and which causes interference, including: a bit selection unit that selects, in a case where a retransmission request signal from the first terminal apparatus is a signal for requesting retransmission, a first coded bit sequence to the first terminal apparatus, which is associated with a redundancy version including the largest number of systematic bits; and a terminal information generation unit which generates the terminal information.

Such a base station apparatus is able to transmit, to a terminal apparatus, the coded bit sequence, which is associated with the redundancy version which includes the largest number of systematic bits, as a retransmission signal. Moreover, the base station apparatus is able to notify the terminal apparatus of terminal information which is information of another terminal apparatus and causes interference. Accordingly, the terminal apparatus is able to perform interference suppression and cancellation with high efficiency, thus reception quality being improved.

(2) The base station apparatus of the invention is the base station apparatus described in the aforementioned (1), in which the first terminal apparatus is able to be configured to be in a first transmission mode in which interference suppression and cancellation is defined, and the bit selection unit selects the first coded bit sequence in a case where the first terminal apparatus is configured to be in the first transmission mode.

Such a base station apparatus is able to transmit, to the terminal apparatus which is configured to be in the first transmission mode in which interference suppression and cancellation is defined, the coded bit sequence which is associated with the redundancy version including the largest number of systematic bits. Accordingly, the terminal apparatus which is configured to be in the first transmission mode is able to perform interference suppression and cancellation with high efficiency, thus reception quality being improved.

(3) The base station apparatus of the invention is the base station apparatus described in the aforementioned (1), in which the bit selection unit selects a second coded bit sequence to the second terminal apparatus, and the second coded bit sequence is associated with the redundancy version which includes the largest number of systematic bits.

Such a base station apparatus is able to transmit, to the second terminal apparatus, the coded bit sequence which is associated with the redundancy version including the largest number of systematic bits. Accordingly, each of the first and the second terminal apparatuses is able to perform interference suppression and cancellation with high efficiency, thus reception quality being improved.

(4) The base station apparatus of the invention is the base station apparatus described in the aforementioned (3), in which transmission is performed to the second terminal apparatus in a first transmission mode in which the interference suppression and cancellation is defined.

Such a base station apparatus is able to transmit, to the terminal apparatus which is configured to be in the first transmission mode in which interference suppression and cancellation is defined, the coded bit sequence which is associated with the redundancy version including the largest number of systematic bits. Accordingly, the terminal apparatus which is configured to be in the first transmission mode is able to perform interference suppression and cancellation with high efficiency, thus reception quality being improved.

(5) A terminal apparatus of the invention is a terminal apparatus serving as a first terminal apparatus that is notified, from a base station apparatus, of terminal information which is information of a second terminal apparatus and which causes interference, in which a first transmission mode which allows interference suppression and cancellation using the terminal information is defined between the base station apparatus and the first terminal apparatus, and, in a case where the first terminal apparatus is configured to be in the first transmission mode, the first terminal apparatus performs depuncturing related to a redundancy version which includes the largest number of systematic bits on a signal even if the signal is a retransmitted signal.

In a case where such a terminal apparatus is configured to be in the first transmission mode which allows interference suppression and cancellation, the terminal apparatus is able to perform depuncturing related to the redundancy version which includes the largest number of systematic bits on a signal even if the signal is a retransmitted signal. Accordingly, the terminal apparatus which is configured to be in the first transmission mode is able to perform interference suppression and cancellation with high efficiency, thus reception quality being improved.

(6) The terminal apparatus of the invention is the terminal apparatus described in the aforementioned (5), in which the depuncturing related to the redundancy version which includes the largest number of systematic bits is performed on a signal to the second terminal apparatus.

Such a terminal apparatus is able to perform depuncturing related to the redundancy version which includes the largest number of systematic bits on the signal to the second terminal apparatus. Accordingly, the terminal apparatus is able to perform interference suppression and cancellation with high efficiency, thus reception quality being improved.

(7) The terminal apparatus of the invention is the terminal apparatus described in the aforementioned (6), including a signal detection unit which performs, in a case where the terminal apparatus is configured to be in the first transmission mode, the interference suppression and cancellation.

In a case where such a terminal apparatus is configured to be in the first transmission mode which allows interference suppression and cancellation, the terminal apparatus is able to perform interference suppression and cancellation with high efficiency, thus reception quality being improved.

(8) The terminal apparatus of the invention is the terminal apparatus described in the aforementioned (7), in which at least a part of interference suppression and cancellation performed by the signal detection unit is interference suppression and cancellation on a code word level.

Such a terminal apparatus is able to perform interference suppression and cancellation on the code word level for a part of interference signals, thus reception quality being improved.

(9) An integrated circuit of the invention is an integrated circuit that is mounted on a base station apparatus to notify a first terminal apparatus of terminal information which is information of a second terminal apparatus and which causes interference, and that causes the base station apparatus to exert a plurality of functions including a series of functions of selecting, in a case where a retransmission request signal from the first terminal apparatus is a signal for requesting retransmission, a first coded bit sequence to the first terminal apparatus, which is associated with a redundancy version including the largest number of systematic bits, and generating the terminal information.

With such an integrated circuit, the base station apparatus is able to transmit, to a terminal apparatus, the coded bit sequence, which is associated with the redundancy version including the largest number of systematic bits, as a retransmission signal. Moreover, the base station apparatus is able to notify the terminal apparatus of terminal information which is information of another terminal apparatus and causes interference. Accordingly, the terminal apparatus is able to perform interference suppression and cancellation with high efficiency, thus reception quality being improved.

(10) An integrated circuit of the invention is an integrated circuit that is mounted on a first terminal apparatus to be notified, from a base station apparatus, of terminal information which is information of a second terminal apparatus and which causes interference, and that causes the first terminal apparatus to exert a plurality of functions including a series of functions of defining, between the base station apparatus and the first terminal apparatus, a first transmission mode which allows interference suppression and cancellation using the terminal information, and performing, in a case where the first terminal apparatus is configured to be in the first transmission mode, depuncturing related to a redundancy version, which includes the largest number of systematic bits, on a signal even if the signal is a retransmitted signal.

With such an integrated circuit, in a case where a terminal apparatus is configured to be in the first transmission mode which allows interference suppression and cancellation, the terminal apparatus is able to perform depuncturing related to the redundancy version which includes the largest number of systematic bits on a signal even if the signal is a retransmitted signal. Accordingly, the terminal apparatus which is configured to be in the first transmission mode is able to perform interference suppression and cancellation with high efficiency, thus reception quality being improved.

### Advantageous Effects of Invention

According to the invention, also in a wireless communication system using HARQ, a terminal apparatus is able to achieve interference suppression performance with high accuracy, thus transmission quality is improved, which contributes to significant improvement in frequency efficiency of the wireless communication system.

### BRIEF DESCRIPTION OF DRAWINGS

FIG. 1 is a schematic view illustrating an example of a communication system according to a first embodiment of the invention.

FIG. 2 is a block diagram illustrating a configuration example of a base station apparatus according to the first embodiment of the invention.

FIG. 3 is a block diagram illustrating a configuration example of a coding unit according to the first embodiment of the invention.

FIG. 4 is an explanatory view of a bit selection unit according to the first embodiment of the invention.

FIG. 5 is a block diagram illustrating a configuration example of a terminal apparatus according to the first embodiment of the invention.

### DESCRIPTION OF EMBODIMENTS

An embodiment in a case where a wireless communication system of the invention is applied will be described below with reference to drawings. Note that, what is described in the embodiment is one aspect for understanding the invention, and contents of the invention should not be interpreted being limited to the embodiment.

### 1. First Embodiment

A first embodiment of the invention will be described below. A communication system in the present embodiment includes a base station (a transmission apparatus, a cell, a transmission point, a transmit antenna group, a transmit antenna port group, a component carrier, or eNodeB) and a terminal (a terminal apparatus, a mobile terminal, a reception point, a reception terminal, a reception apparatus, a receive antenna group, a receive antenna port group, or UE).

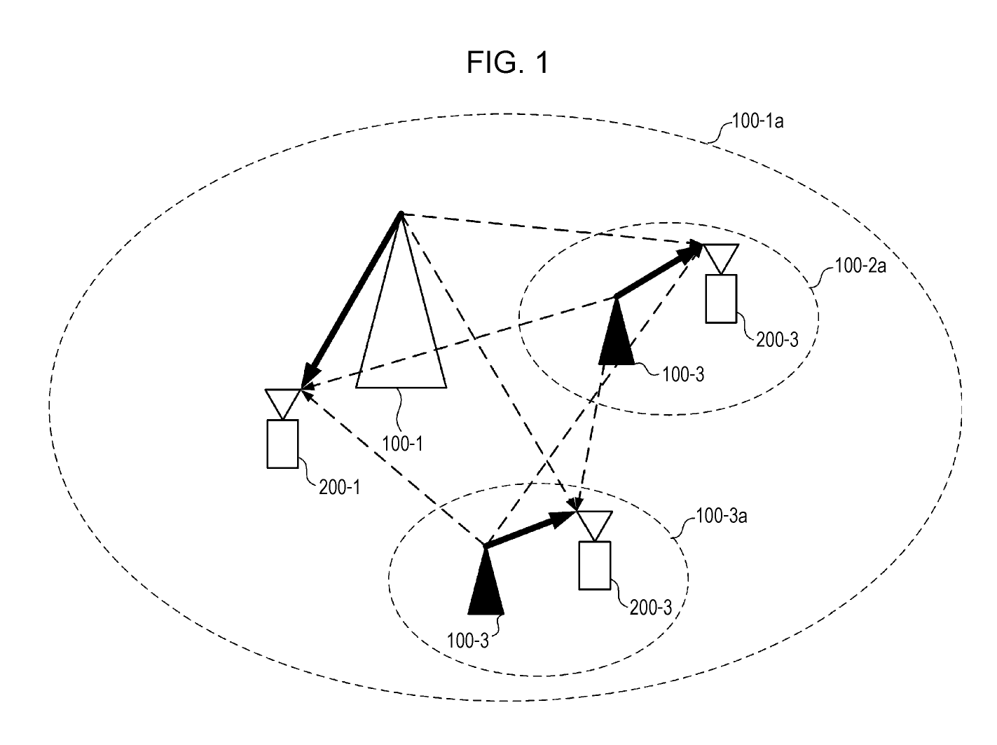

FIG. 1 is a view illustrating an example of the communication system according to the first embodiment. In FIG. 1, a base station apparatus (also referred to as a macro base station or a first base station) 100-1, base station apparatuses having lower transmit power than that of the macro base station (also referred to as LPNs: Low Power Nodes, low power base stations, or second base stations) 100-2 and 100-3, and terminal apparatuses 200-1, 200-2, and 200-3 are provided. 100-1a denotes coverage (macro cell) of the macro base station 100-1, and 100-2a and 100-3a respectively denote coverage (pico cell, small cell etc.) of the low power base stations 100-2 and 100-3. The coverage is a range in which the base station apparatus is able to be connected to the terminal apparatuses (communication area). Although the following describes an example in which the macro base station and the low power base station construct a multi cell, the invention is not limited thereto, and the macro base stations alone may construct a multi cell or the low power base stations alone may construct a multi cell. Further, the base station apparatuses may be connected to each other in a wireless manner or by cable. Moreover, a plurality of terminal apparatuses may be connected to one base station apparatus, or conversely, one terminal apparatus may be connected to a plurality of base station apparatuses.

When there are a plurality of low power base stations, each low power base station may have different transmit power. The macro base station and the low power base station may be distinguished by transmit power, or the discrimination may be performed between a base station having backward compatibility that supports a scheme which has already launched and a base station having no backward compatibility, which is newly defined. In addition, the macro base station and the low power base stations may be distinguished by the number of antennas which are arranged, a method of arrangement of the antennas (linear array antenna, planar array antenna, or polarized array antenna), a function of the antennas (active, passive), or the like.

Schemes that provide service (versions of a communication system, options, etc.) may be different between the low power base stations.

In the invention, the number of cells, the number of base stations, the number of terminal apparatuses, types of cells (for example, a macro cell, a pico cell, a femto cell, a small cell, etc.), and types of base stations are not limited to the embodiment below. The small cells are completely overlapped with the macro cell in FIG. 1, but may be partially overlapped or may not be overlapped therewith.

### [1. 1. Base Station Apparatus]

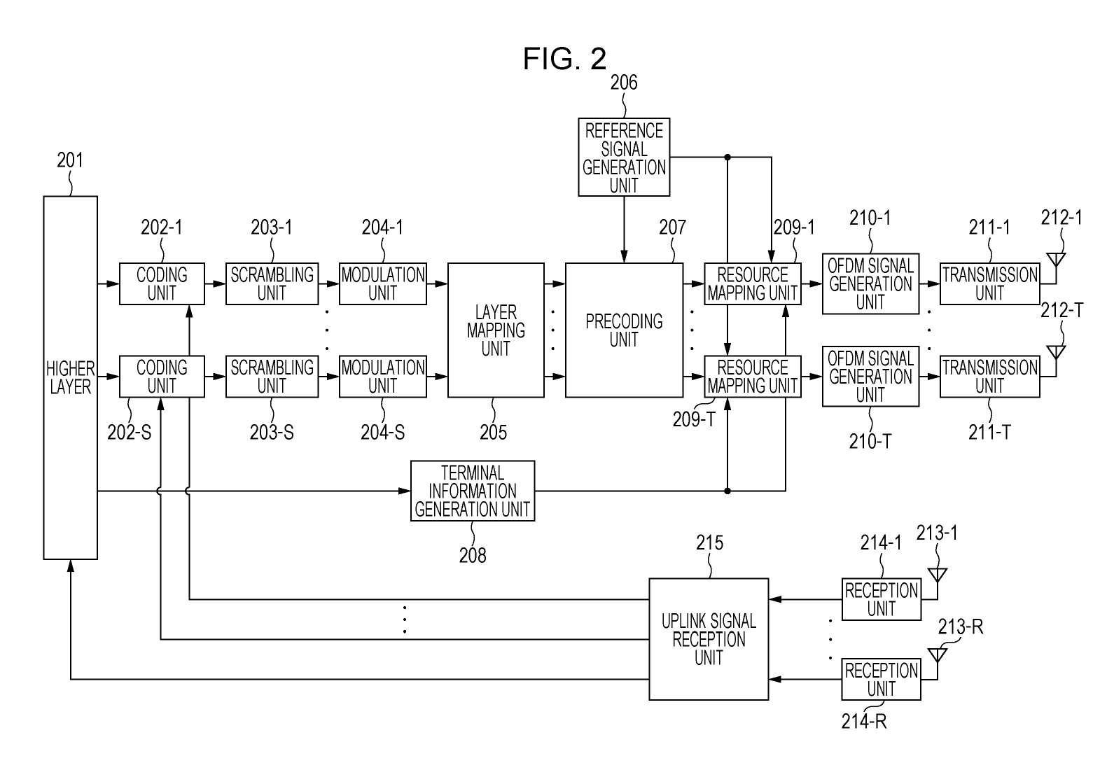

FIG. 2 is a schematic block diagram illustrating a configuration of the base station apparatus in the present embodiment. The base station apparatus includes a higher layer 201, coding units 202-1 to 202-S, scrambling units 203-1 to 203-S, modulation units 204-1 to 204-S, a layer mapping unit 205, a reference signal generation unit 206, a precoding unit 207, a terminal information generation unit 208, resource mapping 209-1 to 209-T, OFDM signal generation units 210-1 to 210-T, transmission units 211-1 to 211-T, transmit antennas 212-1 to 212-T, receive antennas 213-1 to 213-R, reception units 214-1 to 214-R, a report information detection unit 215, receive antennas 213-1 to 213-R, reception units 214-1 to 214-R, and an uplink signal reception unit 215. In the figure, S denotes the number of spatially multiplexed streams. T denotes the number of transmit antennas. In addition, R denotes the number of receive antennas. Though T=R normally, the present embodiment also includes a case where R and T are different between uplink and downlink due to, for example, a change in the number of RF (Radio Frequency) circuits to be used. Note that, when a part or all of the aforementioned base station apparatus is formed into a chip to be an integrated circuit, a chip control circuit that controls each functional block is provided.

The higher layer 201 is a hierarchy of a function higher than a physical layer among hierarchies of communication functions defined by an OSI reference model, for example, a MAC (Media Access Control) layer, a data link layer, a network layer, or the like. Moreover, the higher layer 201 also notifies other parameters needed for each part constituting the base station apparatus to exert a function.

The coding units 202-1 to 202-S perform error correction coding for information data input from the higher layer 201, and after performing rate matching (puncturing), generate coded bits (also referred to as code words). Rate matching processing is performed in order to match a coding rate of a data sequence subjected to the error correction coding with a coding rate corresponding to a data transmission rate. The information data is, for example, an audio signal associated with a call, a still image or moving image signal representing a photographed image, a character message, or the like. A coding scheme used by the coding units 202-1 to 202-S to perform error correction coding is, for example, turbo coding, convolutional coding, low density parity check coding (LDPC), or the like.

The scrambling units 203-1 to 203-S scramble code words input from the coding units 202-1 to 202-S based on each cell ID.

The scrambled code words are mapped onto modulation symbols in the modulation units 204-1 to 204-S. The modulation processing performed by the modulation units 204-1 to 204-S is, for example, BPSK (Binary Phase Shift keying), QPSK (Quadrature Phase Shift Keying), M-QAM (M-Quadrature Amplitude Modulation, for example, M=16, 64, 256, 1024, and 4096), or the like. Note that, the modulation units 204-1 to 204-S may have a function to sort and interleave the generated modulation symbols.

The modulation symbols are subjected to layer mapping for spatial multiplex in the layer mapping unit 205. For example, LTE-A (LTE-Advanced) supports up to eight layers and one code word is subjected to mapping to up to four layers.

The reference signal generation unit 206 generates reference signals, and outputs a reference signal on which precoding needs to be performed to the precoding unit 207, and outputs a reference signal on which precoding is not to be performed to the resource mapping units 209-1 to 209-T.

The precoding unit 207 performs precoding on the output of the layer mapping unit 205. Note that, the same precoding as that of a data signal to be demodulated may be performed on a part of the reference signals, for example, a DMRS (DeModulation Reference Symbol).

The terminal information generation unit 208 generates information of another terminal apparatus (also referred to as terminal information) in order that the terminal apparatus detects and cancels an interference signal. The terminal information is information supporting demodulation and decoding of a signal to the other terminal apparatus such as, for example, a cell ID, a modulation scheme, a coding rate, a reference signal, an antenna port number, resource allocation information, and a redundancy version (RV) of HARQ (Hybrid Auto Repeat reQuest). The terminal information may serve as a control signal.

The resource mapping units 209-1 to 209-T map an output of the precoding unit 207, reference signals, and the terminal information onto resources.

Outputs of the resource mapping units 209-1 to 209-T are transmitted from the transmit antennas 212-1 to 212-T after being subjected to IFFT (Inverse Fast Fourier Transform), insertion of cyclic prefix (CP) in the OFDM (Orthogonal Frequency Division Multiplexing) signal generation units 210-1 to 210-T, and digital/analog transform, filtering, frequency transform from a baseband to an RF band, and the like in the transmission units 211-1 to 211-T.

Note that, the base station apparatus also has a function of receiving an uplink signal transmitted from the terminal apparatus. In the present embodiment, the uplink signal includes a retransmission request signal from the terminal apparatus, and the uplink signal reception unit 215 outputs the retransmission request signal to either or both of the higher layer 201 and the coding units 202-1 to S.

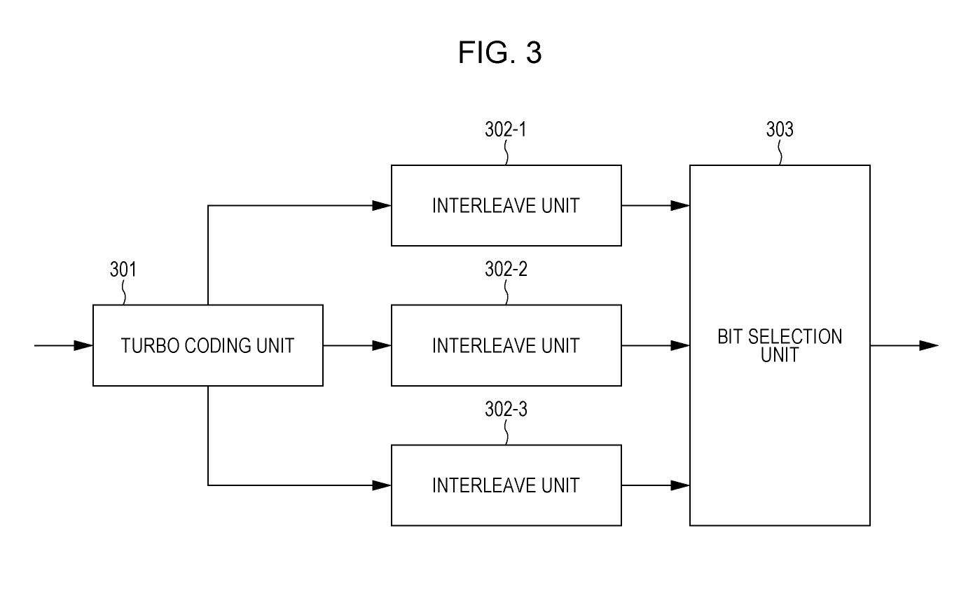

FIG. 3 is a schematic block diagram illustrating an example of a configuration of one coding unit of the coding units 202-1 to 202-S. Here, a case where error correction coding is performed by turbo coding will be described. The coding unit includes a turbo coding unit 301, interleave units 302-1 to 302-3, and a bit selection unit 303. The turbo coding unit 301 performs coding with a certain coding rate. Here, a case where coding is performed with a coding rate of ⅓ will be described. In this case, the turbo coding unit 301 outputs three sequences of a systematic bit sequence, a first parity bit sequence, and a second parity bit sequence. The interleave units 302-1 to 302-3 are sub-block interleavers for interleaving the systematic bit sequence, the first parity bit sequence, and the second parity bit sequence, respectively. The interleave units 302-1 to 302-3 are three blocks in order to perform parallel processing, but only one interleave unit may be provided in a case where serial processing is performed. The bit selection unit 303 performs puncturing on the bit sequences so as to achieve a rate which is determined by the RV, rate matching, or the like and outputs the bit sequences to be transmitted. Note that, the coded bit sequences are held until the terminal apparatus is able to receive information data correctly. The coded bit sequences which are held are able to be used for the HARQ.

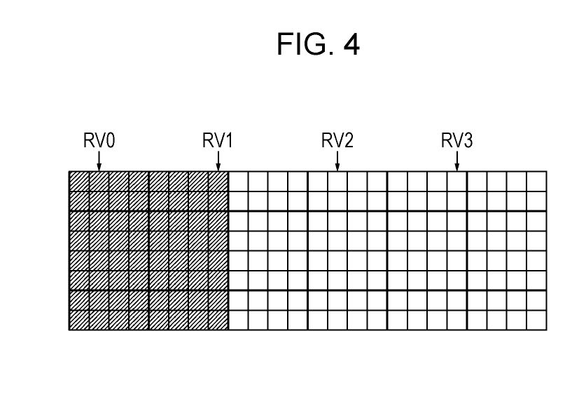

FIG. 4 is a view for explaining processing of the bit selection unit 303. Coded bits after interleaving are arranged in squares in the figure. The systematic bit sequence is arranged in shaded areas and the first parity bit sequence and the second parity bit sequence are arranged alternately in white areas. The required number of bits is read from the arranged bit sequences with the RV as a start position.

For example, the LTE (Long Term Evolution) has four kinds of RVs. Here, the four kinds of RVs are represented as RV0 to RV3. Note that, RV0 to RV3 represent cases where values of the RV are 0, 1, 2 and 3, respectively. Moreover, RV0 includes the largest number of systematic bits among the RVs. Which RV to use is determined according to a retransmission request signal notified from the terminal apparatus. In a case where initial transmission is requested, RV0 is normally used. In a case where retransmission is requested, any of RV0 to RV3 is used.

In the present embodiment, the terminal apparatus connected to the base station apparatus is able to receive terminal information associated with an interference signal from the base station apparatus, and to perform interference suppression and cancellation based on this terminal information. At this time, when the interference signal is a retransmitted signal and the number of systematic bits is small (for example, RV1, RV2, or RV3), performance of error correction decoding considerably deteriorates.

The bit selection unit 303 then performs control so that a coded bit sequence defined by an RV which includes the largest number of systematic bits (that is, RV0) is always transmitted to the terminal apparatus regardless of the retransmission request signal notified from the terminal apparatus. The terminal information generation unit 208 performs control so that information relating to an RV included in the terminal information which causes interference always becomes information associated with the RV0. Note that, the terminal information generation unit 208 may control the terminal information which causes interference so as not to include the information associated with the RV.

Note that, an interference signal and terminal information of this interference signal are transmitted and notified also from a different base station apparatus. In this case, control is performed also on the different base station apparatus so that the interference signal received by the terminal apparatus becomes a coded bit sequence defined by the RV0.

In the LTE, a plurality of transmission modes are defined, and the base station apparatus and the terminal apparatus determine the transmission mode in advance before data transmission. In this case, presence/absence of interference suppression in the terminal apparatus and the transmission mode are associated with each other in some cases. It is assumed that interference suppression and cancellation in the terminal apparatus is defined, for example, only in a transmission mode 10 (first transmission mode). In this case, the bit selection unit 303 performs control only on a terminal apparatus, which is configured to be in the transmission mode 10, so that the coded bit sequence defined by the RV0 is transmitted to the terminal apparatus regardless of a retransmission request signal. In this manner, signal processing in the bit selection unit 303 and the terminal information generation unit 208 is able to be controlled by being associated with a transmission mode between the base station apparatus and the terminal apparatus. Note that, the terminal information generation unit 208 may perform control so that the information relating to the RV included in the terminal information which causes interference always becomes information associated with the RV0, or the information relating to the RV may not be included in the terminal information. Moreover, the terminal information generation unit 208 may be controlled so as to generate terminal information only for a terminal apparatus configured to be in the first transmission mode, or may be controlled so as to always generate terminal information regardless of the transmission mode.

Note that, terminal apparatuses which perform MU-MIMO transmission in which a base station apparatus spatially multiplexes signals to a plurality of terminal apparatuses and transmits the signals, or terminal apparatuses which are connected to a base station apparatus in another cell are configured to be in different transmission modes in some cases. In a case where both a terminal apparatus configured to be in the first transmission mode and a terminal apparatus configured to be in a transmission mode other than the first transmission mode coexist, a base station apparatus to which these terminal apparatuses are connected may perform control so that the coded bit sequence defined by the RV0 is always transmitted to the terminal apparatuses regardless of the transmission mode. Of course, in a case where all the terminal apparatuses are configured to be in a transmission mode other than the first transmission mode, it is not always necessary that the base station apparatus transmits the coded bit sequence defined by the RV0 to the terminal apparatuses.

### [1. 2. Terminal Apparatus]

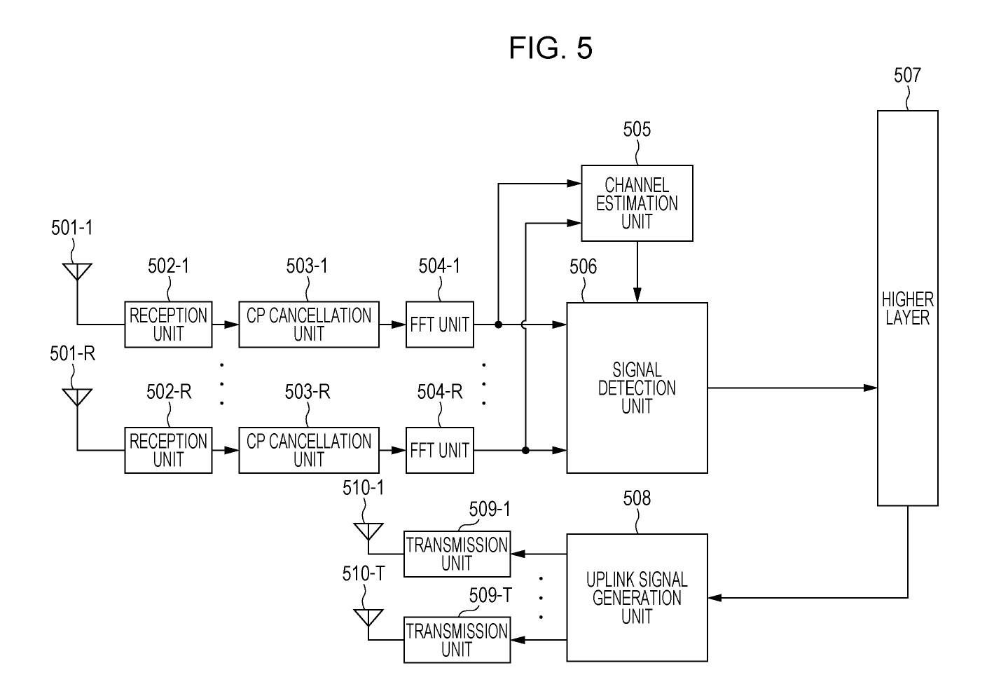

FIG. 5 is a schematic block diagram illustrating a configuration of the terminal apparatus in the present embodiment. The terminal apparatus includes receive antennas 501-1 to 501-R, reception units 502-1 to 502-R, CP cancellation units 503-1 to 503-R, FFT units 504-1 to 504-R, a channel estimation unit 505, a signal detection unit 506, a higher layer 507, an uplink signal generation unit 508, transmission units 509-1 to 509-T, and transmit antennas 510-1 to 510-T. When a part or all of the terminal apparatus is formed into a chip to be an integrated circuit, a chip control circuit (not illustrated) that controls each functional block is provided. Note that, R denotes the number of the receive antennas, and T denotes the number of the transmit antennas. Though R=T normally, the present embodiment also includes a case where R and T are different between uplink and downlink due to, for example, a change in the number of RF circuits to be used.

The terminal apparatus receives signals by the receive antennas 501-1 to 501-R and performs frequency transform into a baseband, filtering, analog/digital transform, and the like at the reception units 502-1 to 502-R. Outputs of the reception units 502-1 to 502-R are subjected to cancellation of cyclic prefix at the CP cancellation units 503-1 to 503-R, and time-frequency transform is performed at the FFT units 504-1 to 504-R. The channel estimation unit 505 obtains a channel estimation value by using a DMRS. When the DMRS has been subjected to precoding, the channel estimation value including precoding is obtained. The signal detection unit 506 cancels an interference signal with which terminal information is notified from the base station apparatus, obtains information data transmitted to the signal detection unit 506, and outputs the information data to the higher layer 507.

Based on an error detection code (for example, cyclic redundancy code (CRC) etc.) or the like which is added to the input information data, the higher layer 507 judges whether or not the information data has been successfully received without an error. When an error is detected, the higher layer 507 generates a signal for requesting retransmission (NACK signal) to the base station apparatus. On the other hand, when an error is not detected, the higher layer 507 generates a signal (ACK signal) for requesting new information data to the base station apparatus. The signal for requesting retransmission or new information data is called a retransmission request signal.

The terminal apparatus also includes a function of transmitting an uplink signal to the base station apparatus. In the present embodiment, the uplink signal includes the retransmission request signal generated by the higher layer 507.

The signal detection unit 506 performs interference suppression according to terminal information notified from the base station apparatus. At this time, an interference signal received by the terminal apparatus is always the coded bit sequence defined by the RV0, so that the signal detection unit 506 is always able to perform interference suppression in consideration of decoding of the interference signal as well.

In order for the terminal apparatus to decode the interference signal, it is necessary to apply depuncturing corresponding to puncturing applied to the coded bit sequence to the interference signal. The puncturing applied to the coded bit sequence is associated with a redundancy version. Accordingly, in the present embodiment, even when the interference signal to be decoded is a retransmission signal, the terminal apparatus only needs to perform depuncturing related to a redundancy version which includes the largest number of systematic bits. Note that, in a case where the redundancy version is not notified, it is allowed to perform the depuncturing related to the redundancy version which includes the largest number of systematic bits.

In the present embodiment, there is no limitation to a specific method of interference suppression in consideration of decoding of the interference signal as well. Examples thereof include a Turbo SIC (Successive Interference Canceller), a Turbo PIC (Parallel Interference Canceller), and MAP (Maximum A posteriori Probability) detection.

Note that, the terminal apparatus does not need to perform interference suppression in consideration of decoding of the interference signal as well for all of received interference signals, and interference suppression without consideration of decoding of the interference signal may be performed as to suppression of a part of the interference signals. Examples of the interference suppression without consideration of decoding of the interference signal include linear detection of a symbol level SIC, a symbol level PIC, MLD (Maximum Likelihood Detection), MLD with a small amount of operations, MMSE (Minimum Mean Square Error) detection, and the like.

Note that, in a case where presence/absence of interference suppression in the terminal apparatus is defined by a transmission mode determined between the terminal apparatus and the base station apparatus, the terminal apparatus is able to perform the interference suppression described above when being configured to be in a transmission mode in which the interference suppression is defined. For example, in a case where interference suppression is defined in the transmission mode 10 (first transmission mode), terminal information of an interference signal to be received is notified from the base station apparatus to a terminal apparatus which is configured to be in the transmission mode 10. At this time, the interference signal which is received by the terminal apparatus is the coded bit sequence defined by the RV0, so that it is possible to perform the interference suppression in consideration of decoding of the interference signal as well. Accordingly, in the case of being configured to be in the first transmission mode, even when the interference signal to be decoded is a retransmitted signal, the terminal apparatus may perform depuncturing relating to the redundancy version which includes the largest number of systematic bits.

In a case where the higher layer 507 detects an error as to information data, the signal detection unit 506 holds a part or all of a received signal including this information data. When receiving a retransmitted signal including the information data, the signal detection unit 506 performs packet combining by using the received signal including the information data, which has been received. Note that, the signal detection unit 506 may not perform packet combining, and may discard the part or all of the received signal including the information data even when the higher layer 507 detects an error.

The signal detection unit 506 may hold a part or all of an interference signal regardless of a result of error detection as to information data. When receiving a signal including a retransmitted signal of the interference signal, the signal detection unit 506 may perform packet combining for the interference signal by using the interference signal which has been received.

Moreover, the higher layer 507 may perform error detection also on an interference signal. Then, the signal detection unit 506 may use, for interference suppression and cancellation, a result of the error detection on the interference signal in the higher layer 507. For example, the signal detection unit 506 may perform interference suppression in consideration of decoding such as the Turbo SIC as well, as to an interference signal in which an error is not detected in the higher layer 507, and the signal detection unit 506 may perform interference suppression by linear signal processing such as the MMSE detection as to an interference signal in which an error is detected.

According to the base station apparatus and the terminal apparatus of the present embodiment, as to an interference signal to be received, the terminal apparatus is able to perform interference suppression in consideration of decoding of the interference signal as well, so that it is possible to improve reception quality and, furthermore, to contribute to improvement in frequency efficiency of a wireless communication system.

### 2. Common in all Embodiments

As above, the embodiment of the invention has been described in detail with reference to drawings, but specific configurations are not limited to the embodiment, and a design and the like which are not departed from the gist of the invention are also included in a scope of claims.

Note that, the invention is not limited to the embodiment described above. The base station apparatus and the terminal apparatus of the invention are not limited to be applied to a terminal apparatus of a cellular system or the like, and, needless to say, are applicable to stationary or unmovable electronic equipment which is installed indoors or outdoors such as, for example, AV equipment, kitchen equipment, a cleaning/washing machine, air conditioning equipment, office equipment, an automatic vending machine, other domestic equipment, and the like.

A program which is operated in the base station apparatus and the terminal apparatus related to the invention is a program which controls a CPU and the like (program that causes a computer to function) so as to realize functions of the aforementioned embodiment related to the invention. In addition, information which is handled by the apparatuses is temporarily accumulated in a RAM at the time of processing thereof, and then stored in various ROMs or an HDD, and is read, modified, and written by the CPU as necessary. A recording medium that stores the program may be any of a semiconductor medium (for example, a ROM, a nonvolatile memory card, or the like), an optical recording medium (for example, a DVD, an MO, an MD, a CD, a BD or the like) and a magnetic recording medium (for example, a magnetic tape, a flexible disc, or the like). Moreover, by executing the loaded program, not only the functions of the embodiment described above are realized, but also by performing processing in cooperation with an operating system, other application programs, or the like based on an instruction of the program, the functions of the invention are realized in some cases.

When being distributed in the market, the program is able to be stored in a portable recording medium and distributed or transferred to a server computer connected through a network such as the Internet. In this case, a storage apparatus of the server computer is also included in the invention. A part or all of the base station apparatus and the terminal apparatus in the embodiment described above may be realized typically as an LSI which is an integrated circuit. Each functional block of the base station apparatus and the terminal apparatus may be individually formed into a processor, or a part or all thereof may be integrated to be a processor. Further, a method for making into an integrated circuit is not limited to using the LSI, and a dedicated circuit or a versatile processor may be used to realize the method. Further, in a case where a technique for making into an integrated circuit in place of using the LSI appears with advance of a semiconductor technique, an integrated circuit by the technique is also able to be used.

### INDUSTRIAL APPLICABILITY

The invention is suitably used for a base station apparatus, a terminal apparatus, and an integrated circuit.

Note that, the international patent application claims priority based on Japanese Patent Application No. 2013-162120 filed on Aug. 5, 2013, and the entire contents of Japanese Patent Application No. 2013-162120 are hereby incorporated by reference.

### REFERENCE SIGNS LIST

100-1, 100-2, 100-3 base station apparatus
200-1, 200-2, 200-3 terminal apparatus
201, 507 higher layer
202-1 to 202-S coding unit
203-1 to 203-S scrambling unit
204-1 to 204-S modulation unit
205 layer mapping unit
206 reference signal generation unit
207 precoding unit
208 terminal information generation unit
209-1 to 209-T resource mapping unit
210-1 to 210-T OFDM signal generation unit
211-1 to 211-T, 509-1 to 509-T transmission unit
212-1 to 212-T, 510-1 to 510-T transmit antenna
213-1 to 213-R, 501-1 to 501-R receive antenna
214-1 to 214-R, 502-1 to 502-R reception unit
215 uplink signal reception unit
301 turbo coding unit
302-1 to 302-3 interleave unit
303 bit selection unit
503-1 to 503-R CP cancellation unit
504-1 to 504-R FFT unit
505 channel estimation unit
506 signal detection unit
508 uplink signal generation unit

1.-10. (canceled)

11. A base station apparatus that communicates with a terminal apparatus, comprising
a terminal information generation unit that
transmits, to a first terminal apparatus, terminal information which is information used for cancelling interference and
generates the terminal information indicating that a signal to a second terminal apparatus which causes interference is associated with a redundancy version including the largest number of systematic bits.

12. The base station apparatus according to claim 11, wherein
in a case where the first terminal apparatus is configured to be in a first transmission mode in which interference suppression and cancellation is defined, the terminal information generation unit generates the terminal information indicating that the signal to the second terminal apparatus is associated with the redundancy version including the largest number of systematic bits.

13. The base station apparatus according to claim 12, further comprising
a bit selection unit that selects a second coded bit sequence to the second terminal apparatus, which is associated with the redundancy version including the largest number of systematic bits.

14. The base station apparatus according to claim 13, wherein
in a case where a retransmission request signal from the second terminal apparatus is a signal for requesting retransmission, the bit selection unit selects the second coded bit sequence.

15. The base station apparatus according to claim 13, wherein
in a case where a retransmission request signal from the first terminal apparatus is a signal for requesting retransmission, the bit selection unit selects a first coded bit sequence to the first terminal apparatus, which is associated with the redundancy version including the largest number of systematic bits.

16. A terminal apparatus that communicates with a base station apparatus,
receives terminal information which is information used for cancelling interference, and
performs, by using the terminal information, depuncturing related to a redundancy version including the largest number of systematic bits on a signal to a second terminal apparatus which causes interference.

17. The terminal apparatus according to claim 16, wherein
in a case where the terminal apparatus is configured to be in a first transmission mode in which interference suppression and cancellation is defined by the base station apparatus, the terminal apparatus performs depuncturing related to the redundancy version including the largest number of systematic bits on the signal to the second terminal apparatus.

18. The terminal apparatus according to claim 17, comprising
a signal detection unit that performs interference suppression and cancellation at least based on the signal subjected to the depuncturing.

19. The terminal apparatus according to claim 18, wherein
at least a part of the interference suppression and cancellation performed by the signal detection unit is interference suppression and cancellation on a code word level.

20. An integrated circuit that is mounted on a first terminal apparatus to be notified, from a base station apparatus, of terminal information which is information of a second terminal apparatus and which causes interference, and that causes the first terminal apparatus to exert a plurality of functions including a series of functions of
receiving terminal information which is information used for cancelling interference and
performing, by using the terminal information, depuncturing related to a redundancy version including the largest number of systematic bits on a signal to a second terminal apparatus which causes interference.
